(19) United States
(12) Patent Application Publication
(10) Pub. No.: US 2012/0150706 A1
(43) Pub. Date: Jun. 14, 2012

(54) SINGLE WINDOW BILLING SYSTEM

(76) Inventor: Poya Cara Hashir, Mangalore (IN)

(21) Appl. No.: 13/092,787

(22) Filed: Apr. 22, 2011

(30) Foreign Application Priority Data
Dec. 8, 2010 (IN) 3752/CHE/2010

(51) Int. Cl. G06Q 30/00; G06Q 40/00

(52) U.S. Cl. 705/34; 705/40

(57) ABSTRACT

Embodiments of a computing based single window billing management system are disclosed. The billing management system is accessible to a first party providing service and a second party receiving service form the first party. In an embodiment, the system includes a security module configured to provide secure access to the first party and the second party upon authentication of respective identities. The system further includes a billing module configured to generate one or more bills in accordance with a template and send the one or more bills to a unique identification ID of the second party. In addition, the system include a graphical user interface (GUI) configured to present to the first party and/or to the second party, the one or more bills and associated options upon receiving an input from the first party and/or the second party. The system also includes a payment module configured to process payment requests from the second party, corresponding to the one or more bills associated with the second party.

### FIELD OF THE INVENTION

The present invention relates to a billing system in general and more particularly to a method and system for a single window process for billing activities.

### DESCRIPTION OF THE RELATED ART

With the advent of communication technologies in the last few decades, accessing and sharing information has become easier and quicker. For example, with a click of a mouse, one can purchase an article online and make a payment using net banking facilities provided by almost all modern day financial institutions/banks. Due to popularity of online banking and e-commerce, a number of services and processes have developed that rely on vendor-client model for conducting one or more transactions. Such transactions may include, but not limited to providing of services by a service provider and a consumer availing those services. In almost all such transactions, the service provider generates and sends an invoice/bill to the consumer after a predetermined time.

Conventionally, there exists web applications and software that are used to create and send bills/invoices. Such software and web application do not conform to a single standard and as a result, the bills generated in these software need to be converted to a common format like pdf, which may be used by consumer to view the bills. Further, after the creation of the bills, the bills are just like any other document, which may be sent over email or postal mail after printing. The management of such kind of bills are difficult, since one cannot search through the bills based on date, total amount etc. In addition, payment of the bills is usually done separately through online banking, credit card or other methods. All these systems are independent of each other and as a result, there is no single point or node to perform activities related to billing Furthermore, there are online document managers like Google documents and Scribd; however, none of these provides seamless exchange of documents between two users upon a specified standard template, which helps to manage the documents easily in future.

At least in view of the above, there is a well-felt need for an improved billing management system that solves at least the above-mentioned issues in the art.

### SUMMARY OF THE INVENTION

It is an object of the present invention to obviate the above-mentioned disadvantages in the art.

It is yet another object if the present invention to provide for a single window billing system.

Still further object of the present invention is to provide a billing management system that generates bills/invoices in multiple formats/templates.

Another object of the present invention is to provide a single node for generation of bills, payment of bills, alert notification, etc.

Embodiments of a computing based single window billing management system are disclosed. The billing management system is accessible to a first party providing service and a second party receiving service form the first party. In an embodiment, the system includes a security module configured to provide secure access to the first party and the second party upon authentication of respective identities. The system further includes a billing module configured to generate one or more bills in accordance with a template and send the one or more bills to a unique identification ID of the second party. In addition, the system include a graphical user interface (GUI) configured to present to the first party and/or to the second party, the one or more bills and associated options upon receiving an input from the first party and/or the second party. The system also includes a payment module configured to process payment requests from the second party, corresponding to the one or more bills associated with the second party.

The system also integrates a host of other interactive capabilities that provides various record keeping and sharing options by virtue of a virtual commercial network that brings together various parties subscribed to the system.

These and other advantages would become apparent from the following detailed description of figures.

### BRIEF DESCRIPTION OF DRAWINGS

FIG. 1 illustrates an exemplary system environment for implementing billing management system according to an embodiment of the present invention;

FIG. 2 illustrates an exemplary billing system according to an embodiment;

FIG. 3 illustrates an exemplary method for managing one or more aspects of billing related activities in an embodiment.

### DESCRIPTION OF THE DRAWINGS

Embodiments of system and method are disclosed for managing one or aspects of billing In conventional systems and methods, the billing is performed by a different entity and other related activities, such as, but not limited to, payment of bills, generation in different formats, alert notification, etc. would be performed by a separate system entity. Due to different disadvantages of such scattered execution of billing related activities and lack of flexibility of operations, there is a well-felt need for a single node system for billing that performs all the related activities and provides for a single platform to manage or administer one or more aspects of billing and other well-known interactive options.

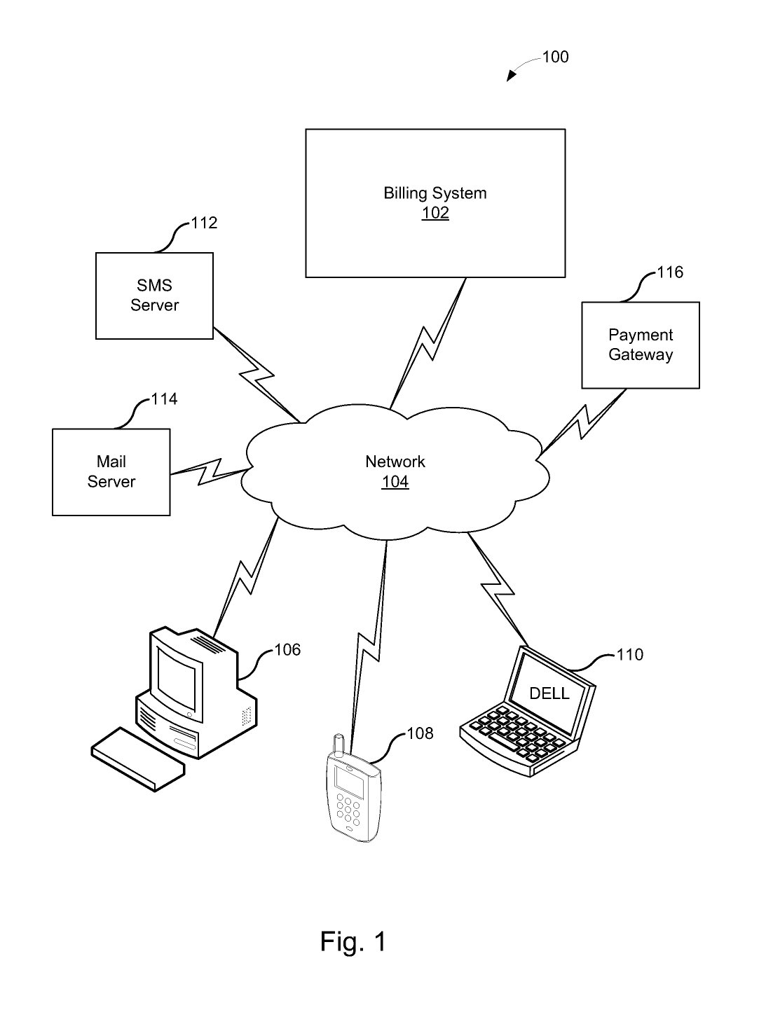

To this end, FIG. 1 illustrates a system environment 100 that implements the single window billing system 102 according to an embodiment. As shown in FIG. 1, the system environment 100 includes the billing system 102 that communicates via. a network 104 with one or more computing devices, such as, a desktop computer 106, a mobile device 108, a laptop computer 110 or the like. The network 104 may be a 3^{rd} Generation network (3G) and may include one or more of Wide Area Network (WAN), Metropolitan Area Network (MAN), Wireless Local Area Networks (WLAN conforming to IEEE 802.11 standards), and WiMAX (IEEE 802.16). The computing devices may also be a handheld portable computing device such as, but not limited to, a cellular phone, a personal digital assistant (PDA), a notebook PC, and the like, that has communication capabilities and has in-built display supported by advanced video processing capabilities.

The system environment 100 further includes an SMS server 112 that is configured to send one or more text messages via. Short Message Service. Similarly, the system environment 100 includes a mail server 114 that is configured to trigger one or mails to an intended recipient. The system environment 100 also includes a payment gateway 116 that enables the billing system 102 to perform payment related activities. Although, the SMS server 112, the mail server 114, and the payment gateway 116 have been shown as separate blocks outside of the billing system 102, it may be appreciated by those skilled in the art that the SMS server 112, the mail server 114, and the payment gateway 116 may be incorporated in the billing system itself to implement a single window billing management system.

In an exemplary implementation, there would be at least two interested parties using the billing system 102. A first party corresponding to a vendor or a service provider would have one or more service or product offerings. The second party on the other hand corresponds to the consumer or the recipient of the service and/or product offerings. An exchange of services or products between the first party and the second party has been referred to as a “transaction” for the purposes of the ongoing description. Although, for purposes of exemplary illustration, the following description uses two parties (the first and the second user), it may be appreciated by those skilled in the art that the system and method disclosed herein applies to a plurality of users or multiple parties who have subscribed to the single window billing system.

For instance, an exemplary scenario for implementation of the billing system 102 would include one or more vendors providing services and/or products to one or more consumers. In such a scenario, the parties would have agreed upon the terms and conditions for providing/availing services. The terms and conditions may include amongst other details, the rate at which the services and/or products would be billed.

Typically, within a predetermined number of days from the transaction, the first party or the vendor would want to generate and send a bill to the second party or the consumer. To this end, the billing system 102 would provide secure access to the first party and the second party upon authentication of respective identities. In an implementation, the billing system 102 generates and provides a unique identification ID to the first party and the second party respectively.

Unique identification ID can correspond to mobile number of the first party and the second party in a reverse order. Upon verification of user credentials, for example, of the first party, the billing system 102 generates one or more bills in accordance with a template and sends the one or more bills to a given unique identification ID of the second party. The billing system 102 generates the one or more bills based at least in part on predetermined rate plans.

The billing system 102 may be accessible to the second party in a similar way as for the first party. The second party, for example, upon verification of user credentials can select a given transaction and see the corresponding bills/invoices generated by the first party. The billing system 102 can therefore present, to the first party and/or to the second party, the one or more bills and associated options upon receiving an input from the first party and/or the second party.

The second party may view the generated bill in a format/template selectable from a plurality of templates. The billing system 102 can present, along with the generated bill, one or more options associated with the bill. One such option can be the payment of the bill using net banking or online banking using financial institutions. The second party selects the payment option for making a payment. The payment gateway 116 is configured to process such payment requests from the second party, corresponding to the one or more bills associated with the second party.

The billing system 102 also enables the first party and/or the second party to search for one or more bills based on an appropriate input. To this end, the billing system 102 includes a database of generated bills indexed according to one or more fields such as the name, contact details, email ID, contact number, etc. Either of the party, upon successful login to the billing system 102, can provide any of the fields as an input for searching one or more bills in the database.

Since, the billing system 102 is a standalone node, the user details of the first party and the second party are stored in the billing system 102 for authentication purposes and otherwise. The billing system 102, in various other embodiments, provides for options to the first party and the second party to manage their profiles. In yet another embodiment, the billing system 102 can generate and send notifications and alerts to the first party and/or the second party responsive to occurrence of one or more events.

The billing system 102 further includes user profiling capabilities resulting in formation of a virtual network or parties or users capable of communicating with each other using the billing system 102. It may be appreciated that the billing management system can be implemented as online system remotely accessible by the first party and the second party using the communication devices, such as, 106, 108, and 110.

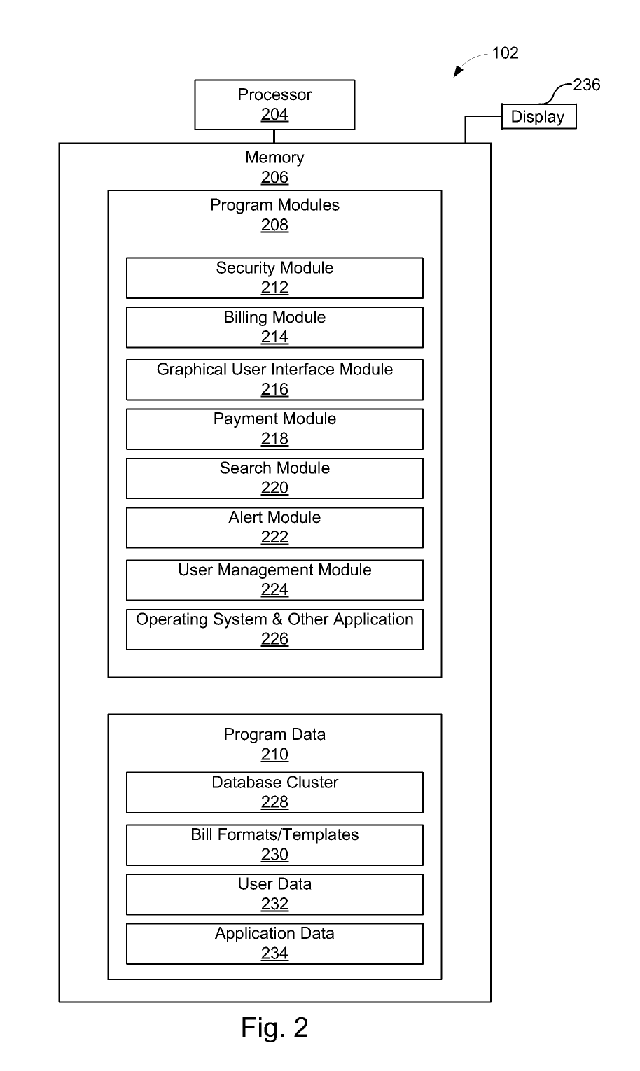

FIG. 2 illustrates billing system 102 in accordance with an embodiment. The computing based single window billing system 102 is accessible to a first party providing service and a second party receiving service form the first party. In an exemplary embodiment, the billing system 102 can be based on Single Source of Truth (SSOT) practice of information systems design and theory. The Single Source of Truth (SSOT) systems provide data that is authentic, relevant, and referable.

As shown, the billing system 102 includes one or more processors 204 coupled with a memory 206. The memory itself can be subdivided into one or more program modules 208 and program data 210. The processor 204 accesses the memory 206 and executes the one or more program modules 208 and stores related data in program data 210.

The program module 208 includes a security module 212 configured to provide secure access to the first party and the second party upon authentication of respective identities. In an implementation, the security module is further configured to generate and provide a unique identification ID to the first party and the second party respectively. Unique identification ID can be generated by using the mobile number of the first party/and or the second party respectively. In an embodiment, the unique identification ID corresponds to the mobile number in a reverse order with or without country code.

Generally, the likelihood of users remembering their mobile/cellular phone numbers is higher than them remembering their bank account numbers. The billing system 102 according to the present invention discloses a single window process for all the billing related activities and a unique ID is generated for each of the first party and the second party. The unique ID can be different from their email ID and phone numbers. According to yet another embodiment, the unique ID may be equivalent to bank account number. For purposes of illustration, the unique ID has been referred to as BillMail ID in this description. The unique feature that differentiates such a unique ID (BillMail ID) from existing bill creation or management software is the concept of BillMail ID itself. Each of the users (first party or the second party) will have a specific and unique ID which is termed as “BillMail ID”. The communication may be carried out through the allotted ID which is the hub of all their bills. According to yet another embodiment, the BillMail ID (unique ID) may be assigned a random number generated by the billing system 102. BillMail ID envisages getting the bills, payment options, & receipts (all three or any two) into the same platform/domain so that seamless integration between the operations is possible. The current systems and methods do not allow for seamless integration of payment options/gateways and bill receipts in the same platform.

The security module 212 can also help manage situation, where multiple users access a given account. A system administrator or the account owner may set security levels for each other user. Further, all business and personal contacts may be stored to send and receive bills easily. The security module 212 further provides enhanced security and privacy to the users or account holders. With the use of an SSL certificate, the present invention provides security against hackers. In an exemplary embodiment, BillMail ID application is built on Ruby on Rails framework, which is well known for the security and stability.

The billing system 102 further includes a billing module 214 configured to generate one or more bills in accordance with a template and send the one or more bills to a unique identification ID of the second party. The first party logs into the billing system and issues a command to generate bills/invoice corresponding to a past transaction with the second party. In an implementation, the bill module 214 generates the one or more bills based at least in part on predetermined rate plans. Such rate plans may be agreed upon by the first party and the second party prior to the commencement of any transaction there between. The first party can optionally send the generated one or more bills by the billing module 214 to the second party via. an electronic mail (e-mail) or an SMS text. The e-mail is sent to the unique ID or a BillMail ID described above. In an embodiment, the one or more bills sent by the first party may be received in a BillMail ID inbox of the second party, just like an email account. The second party will have all the controls over received bills and may also accept or reject the bills, take print and even pay the bills at the mailbox interface.

The billing system 102 includes a graphical user interface (GUI) module 216 configured to present to the first party and/or to the second party, the one or more bills and associated options upon receiving an input from the first party and/or the second party. As would be appreciated, viewing of the generated bill enables a user (e.g. first party, second party) to verify the contents of the bill, make corrections wherever necessary. Further, the GUI module 216 can also present to the user with a print preview of the generated bill and provides for multiple viewing options as per user's choice of templates. In an exemplary implementation, the first party and/or the second party can select a template for generating bills out of a plurality of predefined templates.

The billing system 102 includes a payment module configured to process payment requests from the second party, corresponding to the one or more bills associated with the second party. As discussed earlier, the first party generates one or more bills corresponding to one or more transactions with the second party. The second party can login to the billing system 102 and view any bills generated for him In an implementation, the GUI module 216 presents the second party with various options associated with the bill being viewed. The associated options can correspond to payment for settling the one or more bills, selecting a template for the bill, setting printing options, and the like. The second party can select the payment option for payment of the one or more bills. The payment module 218 receives such payment request and processes the same via. the payment gateway 116. The payment module 218, for example, can seek for one or more details associated with the second party for making an online payment. Such details can include the second party's bank account number, credit card details, debit card details, net banking details, etc. The payment module 218 sends such details to the payment gateway 116 for processing the payment and transferring the requisite amount from the second party's account to the first party's account.

In a further embodiment, the payment module 218 enables sending, receiving credit notes and debit notes etc. between different parties subscribed to the billing system 102. The billing system 102 further includes a search module 220 configured to search for one or more bills based on an input from the first party and/or the second party. It may be desirable to search for an old bill for record keeping purposes. The search module 220 enables the user (first party and/or the second party) to search for one or more bills using one or more data fields. As described earlier, the billing system 102 maintains a database of bills in database cluster 228, associated first party, and second party details. The database cluster 228 in the program data 210 can be index searched using the data fields to provide for quick search turn around.

The billing system 102 also includes a user management module 224 configured to manage data associated with the first party and the second party. The billing system 102 provides for registration of users (first party and the second party) who have subscribed to the billing system 102. The registration process involves acquisition of user details or data associated with the first party and the second party and can include name, contact details, telephone numbers, mobile numbers, electronic mail IDs, bank account details of the first party and the second party respectively. All such data is stored in the program data in user data 232. In yet another embodiment, the user management module 224 enables creation of a commercial network of parties subscribing to the billing system 102. The user management module 224 creates and maintains profiles of the parties and provides various options for interacting with other parties in the commercial network. For example, the first party may be provided an option to post a message for the second party via. the graphical user interface 216. Similarly, the second party may view the posted message and may respond to the first party. Further capabilities, such as, instant messaging, may also be provided to the parties.

Such a commercial network may also evolve into closed associate groups of like-minded parties or parties with common interest. In effect, the user management module 224 creates a virtual market place where business transactions can be performed with utmost ease and comfort of a laptop, palmtop, desktop, or even a smart phone. It would be appreciated by those skilled in the art that for any business transactions to occur, the payment module 218 implements a built-in payment gateway that facilitates making or receiving a payment.

In an exemplary embodiment, the billing system 102 may implement a seeker-provider platform which matches requirements of one party to the availabilities of another party.

The user management module 224 may present a Profile ID page & Virtual Profile Card (VPC) for parties subscribing to the billing system 102. Such profile pages and cards can be triggered & sent to subscribers/non-subscribers through various methods like single click, SMS etc. Such a concept of user profile provides an addition level of communication which is smaller than a website but more active mode of communication than actually speaking to the person or accessing the web site.

In addition, the user management module 224 via. the graphical user interface, a Document ID page that can serve as a place to store documents, a medical ID page that serves as a place to store medical records, a Shuffle ID page that serves as a forum where buyers & sellers can pen their thoughts & rate of purchases etc., a Money transfer ID that serves as a money transfer mechanism identifier, and a MoneysX ID that can serve as a Money exchange mechanism.

The billing system 102 includes an alert module 222 configured to generate and send notifications and alerts to the first party and the second party responsive to occurrence of one or more events. The alert module 222 may be configured to trigger alert mails or messages upon occurrence of one or more events. Such events may include, but not limited to, transmittal of the one or more bills, receipt of payment, change in rate plans for billing, and delay in payment of bills and the like. The alert module 222 can also integrate the BillMail ID with email and mobile numbers to send/receive alerts 24/7. The billing system 102 can serve as a common point to view such alerts, notifications, and take appropriate actions for the same.

It may be appreciated that although the billing system 102 shown in FIG. 2 illustrates various modules according to an embodiment of the present invention. The billing system 102 may include, but not limited to, a database cluster 228, a Rails application server cluster (not shown), a payment gateway 116, a SMS server 112, and a mail server 114, all configured to constitute the single window billing system 112 of the present invention.

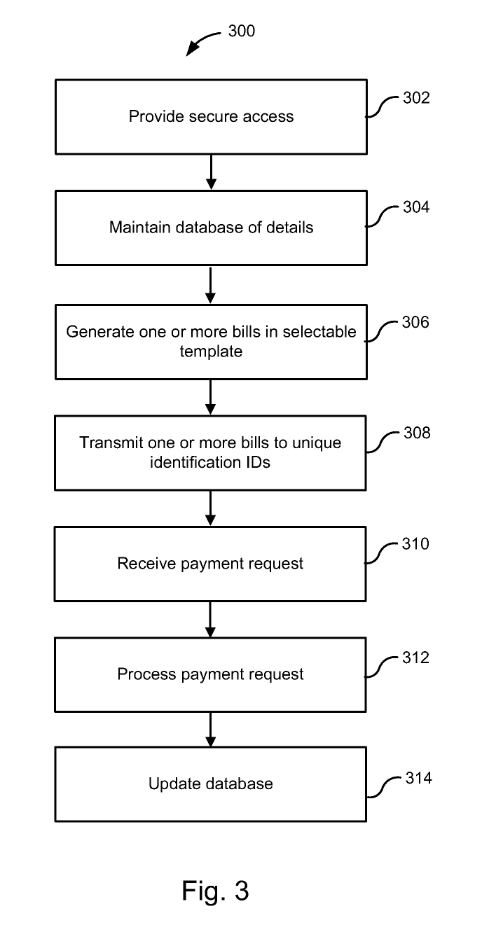

FIG. 3 illustrates an exemplary method 300 for managing one or more aspects of billing in a single window online billing system. The billing system can be subscribed to by one or more vendors and one or more customers.

Accordingly, at 302, a secure access to the one or more vendors and the one or more customers is provided subsequent to corresponding subscriptions. The security module 212 enables registration of the first party (one or more vendors) and the second party (one or more consumers). In an implementation, the billing system 102 can be available for subscription to users upon payment of a predetermined fee. In an implementation, the providing includes generating and sending unique identification IDs to the one or more vendors and one or more customers respectively. The security module 212 generates and sends a unique identification ID, such as, BillMail ID, to the subscribers (i.e. the vendors and the customers).

At 304, a database of details, relating the one or more vendors and the one or more customers associated with each other by way of one or more transactions, is maintained. The billing system 102 maintains a database cluster 228 that would store details relevant for management of user. In particular, the user management module 224 maintains records of user details in program data 210. The details relating the one or more vendors and the one or more customers include any or all of name, contact details, telephone numbers, mobile numbers, electronic mail IDs, bank account details of the one or more vendors and the one or more customers, description of the one or more transactions, and the predetermined parameters. In an implementation, the one or more transactions correspond to an instance of usage of one or more services by the one or more customers, the services being provided by the one or more vendors.

At 306, one or more bills in a selectable template, based on an input from the one or more vendors, are generated. The one or more bills correspond to the one or more transactions between the one or more vendor and the one or more customers based on predetermined parameters. The billing module 214 generates one or more bills according to a template selected by the one or more vendor. As described earlier, the bill template can be selected from a plurality of templates stored in bill formats/templates 230 in program data. The GUI module 216 may present the one or more vendors with options to select or customize the templates for generation of the one or more bills.

At 308, one or more bills are transmitted to unique identification IDs of the one or more customers. The billing module 214 sends the generated one or more bills to a BillMail ID of one or more customers. The BillMail ID may correspond to a mailbox ID of the one or more customers. In an embodiment, the transmitting includes sending the one or more bills via. electronic mail and/or Short Message Service (SMS). In yet another embodiment, the transmitting includes sending an electronic mail notification and/or alert to the one or more customers informing the transmittal of the one or more bills to corresponding unique identification IDs.

At 310, a payment request is received from the one or more customers towards settlement of the one or more bills. The one or more customers or the second party can use the GUI presented by the GUI module 216 to select a payment option to settle one or more bills generated by the one or more vendors. The input from the one or more customers is received by the payment module 218. In an embodiment, receiving a payment request comprises acquiring payment details from the database and/or the one or more customers.

At 312, the payment request is processed by associating with one or more financial institutions. The payment module 218 in the billing system 102 associates with payment gateway 116 and one or more financial institutions, such as, banks to facilitate online payment of bills by the second party or the one or more customers. In an implementation, processing the payment request includes communication with at least one payment gateway for transferring funds between bank accounts corresponding to the one or more vendors and the one or more customers respectively.

At 314, the database is updated with details associated with the payment. The payment module 218 monitors the complete payment process and updates all the details of payment as and when received. In an embodiment, the updating comprises sending a payment notification to the one or more vendors and the one or more customers via. electronic mail and/or Short Message Service (SMS).

The disclosed systems and methods have numerous advantages in comparison with the conventional systems. In an implementation, each organization/individual can be allotted a unique BillMailiD which becomes the hub for all their bills. Alternatively, the unique BillMailiD may be connected to a dedicated Bank A/C. The Service Providers/Biller or the first party can generate and send bills/invoices to the BillMailiD of a particular individual/organization, thereby avoiding sending bills to wrong person/address. The users will get a single point access to pay all bills of different utilities. Users will use their dedicated Bank A/C to pay their bills through BillMailiD. Payment modes integrated to the system may be through mobile banking, mobile transfers, internet banking, aggregator system, debit card, credit card as also cash cards, cash & cheques. The cash cards are a unique concept of encrypting cash into cards matching that code with the code available with the bank & then assigning to the account to change account with money & then assigning that money through internet banking to pay bills and the various modes will be available at bank counters, franchisee bill collection & bill payment franchisees, ATM's & Kiosks (manned & unmanned)

The disclosed systems and methods may be applicable to maintenance of documents like medical reports, legal agreements etc., which needs to be received, send, managed, stored, and searched online According to an embodiment of the present invention, a common standard is applied for the received, sent bills to make it easier to create, send, receive, manage, store, print, and search bills. In an embodiment of the present invention, all the bills are generated, send, received, and stored in the same database, which gives a unique standard for processing of all bills. The present invention enables managing, searching and paying of all the bills from a single login. According to yet another embodiment, all the created bills and received bills are stored permanently.

In yet another embodiment, the system may be implemented in Internet system where all the different documents are exchanged between people upon a standard format, available under different templates. The first party can select a template from a plurality of provided template, set a template as default bill template, create, and send bills. The first party may send the created bills to other BillMail ID users as well as non-BillMail ID users.

In still further embodiment, the Application Program Interface (API) of the disclosed billing system 102 accepts bills generated by other billing software. In cases where it is not supported, users may attach and send manual/scanned bills just like the normal BillMail ID bills. The billing system 102 can get all offline bills to online database cluster 228 and store them permanently and securely. Users may upload and store even the bills received offline through mail. Therefore, the BillMail ID is the single and trusted place for all the bills.

The disclosed systems and methods have many other advantages over the conventional billing systems. For example, all the bills/invoices can be sent from anywhere to anyone using unique BillMailiDs. The disclosed system and method ensures timely delivery of bills and delivery of bills to the correct person. Due to integration of different aspects of billing into a single node of system, there is a very high probability of making/receiving payments on time. The disclosed system and method also eliminates the case where bills/invoices are missed bills/invoices and/or sent to wrong address thereby preventing unintentional late payments.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

I claim:

1. A computing based single window billing management system accessible to a first party providing one or more services/products and a second party receiving the one or more services/products from the first party, the system comprising:
a security module configured to provide secure access to the first party and the second party upon authentication of respective identities;
a billing module configured to generate one or more bills in accordance with a customizable template and send the one or more bills to a unique identification ID of the second party;
a graphical user interface (GUI) configured to present to the first party and/or to the second party, the one or more bills and associated options upon receiving an input from the first party and/or the second party; and
a payment module configured to receive and process payment requests from the second party, the payment request corresponding to the one or more bills associated with the second party.

2. The billing management system as claimed in claim 1, wherein the security module is further configured to generate and provide unique identification IDs to the first party and the second party respectively.

3. The billing management system as claimed in claim 2, wherein the unique identification IDs of the first party and the second party correspond to mobile numbers of the first party and the second party respectively in a reverse order.

4. The billing management system as claimed in claim 1, wherein the billing module generates the one or more bills based at least in part on predetermined rate plans.

5. The billing management system as claimed in claim 1, wherein the first party and/or the second party select the template for bills out of a plurality of predefined templates.

6. The billing management system as claimed in claim 1 further comprising a search module configured to search for one or more bills in a database based on an input from the first party and/or the second party.

7. The billing management system as claimed in claim 1 further comprising a user management module configured to manage data associated with the first party and the second party.

8. The billing management system as claimed in claim 7, wherein the data associated with the first party and the second party comprises name, contact details, telephone numbers, mobile numbers, electronic mail IDs, bank account details of the first party and the second party respectively.

9. The billing management system as claimed in claim 1 further comprising an alert module configured to generate and send notifications and/or alerts to the first party and the second party responsive to occurrence of one or more events.

10. The billing management system as claimed in claim 9, wherein the one or more events comprises: transmittal of the one or more bills, receipt of payment, change in rate plans for billing, and delay in payment of bills.

11. The billing management system as claimed in claim 1, wherein the billing management system corresponds to an online system remotely accessible by the first party and the second party.

12. The billing management system as claimed in claim 1, wherein the associated options comprises bill payment option, bills clarification option, mailing option, printing option, downloading option, template selecting option, and chatting options.

13. In a single window online billing system being subscribed by one or more vendors and one or more customers, a method of managing one or more aspects of billing, the method comprising:
providing a secure access to the one or more vendors and the one or more customers subsequent to corresponding subscriptions;
maintaining a database of details relating the one or more vendors and the one or more customers associated with each other by way of one or more transactions;
generating, based on an input from the one or more vendors, one or more bills in a selectable template, the one or more bills corresponding to the one or more transactions between the one or more vendor and the one or more customers based on predetermined parameters; and
transmitting the one or more bills to unique identification IDs of the one or more customers;
receiving a payment request from the one or more customers towards settlement of the one or more bills;
processing the payment request by associating with one or more financial institutions; and
updating the database with details associated with the payment.

14. The method as claimed in claim 13, wherein the providing comprises generating and sending unique identification IDs to the one or more vendors and one or more customers respectively.

15. The method as claimed in claim 13, wherein the details relating the one or more vendors and the one or more customers comprises any or all of: name, contact details, telephone numbers, mobile numbers, electronic mail IDs, bank account details of the one or more vendors and the one or more customers, description of the one or more transactions, and the predetermined parameters.

16. The method as claimed in claim 13, wherein the generating comprises selecting a template from a plurality of predefined templates.

17. The method as claimed in claim 13, wherein the one or more transactions corresponds to an instance of usage of one or more services by the one or more customers, the services being provided by the one or more vendors.

18. The method as claimed in claim 13, wherein transmitting comprises sending the one or more bills via. electronic mail and/or Short Message Service (SMS).

19. The method as claimed in claim 13, wherein transmitting comprises sending an electronic mail notification and/or alert to the one or more customers informing the transmittal of the one or more bills to corresponding unique identification IDs.

20. The method as claimed in claim 13, wherein transmitting comprises sending a Short Message Service notification and/or alert to the one or more customers informing the transmittal of the one or more bills to corresponding unique identification IDs.

21. The method as claimed in claim 13, wherein receiving a payment request comprises acquiring payment details from the database and/or the one or more customers.

22. The method as claimed in claim 13, wherein processing the payment request comprises communication with at least one payment gateway for transferring funds between bank accounts corresponding to the one or more vendors and the one or more customers respectively.

23. The method as claimed in claim 13, wherein the updating comprises sending a payment notification to the one or more vendors and the one or more customers via. electronic mail and/or Short Message Service (SMS).
